(19) United States
(12) Patent Application Publication
(10) Pub. No.: US 2025/0317714 A1
(43) Pub. Date: Oct. 9, 2025

(54) COMMUNICATION METHOD FOR SENSING BY PROXY MEASUREMENT TERMINATION, AND COMMUNICATION APPARATUS

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/864,868

(22) PCT Filed: May 12, 2022
(86) PCT No.: PCT/CN2022/092531

§ 371 Date: Nov. 11, 2024

(51) Int. Cl. H04W 4/38; H04L 5/00; H04W 76/20

(52) U.S. Cl. CPC H04W 4/38; H04L 5/0053; H04W 76/20

(57) ABSTRACT

A method, apparatus and computer readable medium for terminating a sensing by proxy (SBP) measurement. The SBP measurement is terminated by: receiving, by an access point (AP), a sensing measurement termination message frame transmitted from a first station (STA), wherein the sensing measurement termination message frame comprises a sensing measurement setup identifier corresponding to a sensing measurement procedure; and determining, by the AP, whether to terminate an SBP procedure, wherein the AP is an SBP responder.

### CROSS-REFERENCE TO RELATED APPLICATION

This application is the U.S. national phase application of International Application No. PCT/CN2022/092531, filed on May 12, 2022, the disclosure of which is incorporated herein by reference in its entirety for all purposes.

### TECHNICAL FIELD

The present disclosure relates to the field of wireless communications, and more particularly, to a communication method and a communication apparatus for terminating a sensing by proxy (SBP) measurement.

### BACKGROUND

A wireless local area network (WLAN) has advantages such as flexibility, mobility and low cost. With the development of communication technologies and the growth of user needs, the application research for the WLAN is gradually deepening. For example, WLAN sensing is currently being studied, whose main application scenarios include a location discovery in a dense environment (e.g., a home environment or a company environment), a proximity detection, a presence detection, etc.

### SUMMARY

Various examples of the present disclosure provide the following technical solutions.

According to an example of the present disclosure, a communication method for terminating a sensing by proxy (SBP) measurement is provided. The communication method is performed by an access point (AP) and includes: receiving a sensing measurement termination message frame transmitted from a first station (STA), wherein the sensing measurement termination message frame includes a sensing measurement setup identifier corresponding to a sensing measurement procedure; and determining whether to terminate an SBP procedure, wherein the AP is an SBP responder.

According to an example of the present disclosure, a communication method for terminating an SBP measurement is provided. The communication method is performed by an STA and includes: transmitting a termination message frame to an AP; and receiving an acknowledgment frame from the AP, wherein the AP is an SBP responder.

According to an example of the present disclosure, an electronic device is provided. The electronic device is applied to an AP and includes one or more memories, one or more processors, and a computer program stored on the one or more memories and executable on the one or more processors. The one or more processors are configured to: receive a sensing measurement termination message frame transmitted from a first STA, wherein the sensing measurement termination message frame comprises a sensing measurement setup identifier corresponding to a sensing measurement procedure; and determine whether to terminate an SBP procedure, wherein the AP is an SBP responder.

The technical solutions provided by the examples of the present disclosure improve the termination mechanism of the SBP procedure, which can meet wireless local area network (WLAN) sensing requirements.

### BRIEF DESCRIPTION OF THE DRAWINGS

The described and other features of examples of the present disclosure will become more apparent by describing the examples of the present disclosure in detail with reference to the accompanying drawings.

FIG. 1A to FIG. 1C illustrate examples of WLAN sensing modes.

FIG. 2 is a flowchart illustrating a communication method performed by an AP according to an example.

FIG. 3 is a flowchart illustrating a communication method performed by an AP according to an example.

FIG. 4 is a detailed flowchart illustrating the communication method of FIG. 3 according to an example.

FIG. 5 is a detailed flowchart illustrating the determination of whether to terminate an SBP procedure performed by an AP according to an example.

FIG. 6 is a flowchart illustrating a communication method performed by an AP according to an example.

FIG. 7 is a flowchart illustrating a communication method performed by an STA according to an example.

FIG. 8 is a flowchart illustrating a communication method performed by an SBP initiator STA according to an example.

FIG. 9 is a block diagram illustrating a communication apparatus according to an example.

### DETAILED DESCRIPTION OF THE EMBODIMENTS

The following description with reference to the accompanying drawings is provided to assist in a full understanding of various examples of the present disclosure as defined by the appended claims and their equivalents. Various examples of the present disclosure include various specific details. However, these specific details are regarded as examples only. Furthermore, descriptions of well-known technologies, functions, and constructions may be omitted for clarity and conciseness.

The terms and words used in the present disclosure are not limited to their literal meanings, but are specifically used by the inventor to enable a clear and consistent understanding of the present disclosure. Therefore, for those skilled in the art, the description of various examples of the present disclosure is provided for illustrative purposes only and not for limiting purposes.

It is to be understood that terms defined herein by “a,” “one,” “said” and “the” in their singular forms may also include their plural forms, unless clearly indicated otherwise in the context. It is further to be understood that the term “comprising” as used in the present disclosure refers to the presence of the described feature, integer, step, operation, element and/or component, but does not exclude the presence or addition of one or more other features, integers, steps, operations, elements, components and/or a combination thereof.

Although terms “first,” “second,” and the like may be used in the present disclosure to describe various elements, it is to be understood that these elements should not be limited to these terms. These terms are only used to distinguish one element with another element. Thus, without departing from the teachings of the examples, the first element discussed below may be referred to as the second element.

When a component is referred to as being “connected” or “coupled” to another component, it is to be understood that the component may be directly connected or coupled to another component, or that one or more intermediate components may be present. Furthermore, being “connected” or “coupled” as used herein may include being wirelessly connected or being wirelessly coupled. The term “and/or” or the expression “at least one of . . . ” as used herein includes any or all combinations of one or more associated listed items.

Unless otherwise defined, all terms (including technical and scientific terms) used herein have the same meaning as commonly understood by one of ordinary skill in the art to which the present disclosure belongs.

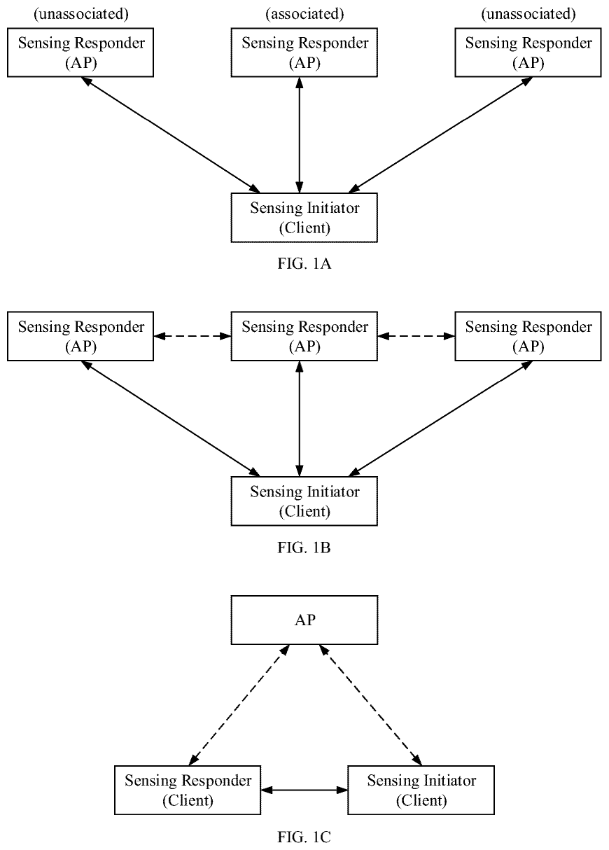

FIG. 1A to FIG. 1C illustrate examples of wireless local area network (WLAN) sensing modes.

A WLAN sensing process may include: an initiator initiates WLAN sensing (for example, it initiates a WLAN sensing session), and there may be multiple responders responding to it. The specific possible modes may be illustrated as FIG. 1A to FIG. 1C. In the following, the term “initiator” may be used interchangeably with “a WLAN sensing initiator” and “a sensing initiator,” and the term “responder” may be used interchangeably with “a WLAN sensing responder” and “a sensing responder”.

Referring to FIG. 1A, when the sensing initiator (e.g., a client) initiates the WLAN sensing, multiple associated or unassociated sensing responders (e.g., three access points (APs)) may respond it. Being “associated” may refer to that an associated connection for communications is established between the initiator and the responder, while being “unassociated” may refer to that no associated connection for communications is established between the initiator and the responder.

As an example, the client may include, but is not limited to, a cellular phone, a smart phone, a wearable device, a computer, a personal digital assistant (PDA), a personal communication system (PCS) device, a personal information manager (PIM), a personal navigation device (PND), a global positioning system, a multimedia device, an Internet of Things (IoT) device, etc.

The AP may be a wireless switch applied in a wireless network or an access device for the wireless network. The AP may include software applications and/or circuits to enable other types of nodes in the wireless network to communicate externally and internally to the wireless network through the AP. As an example, the AP may be a terminal device or a network device equipped with a wireless fidelity (Wi-Fi) chip.

FIG. 1B is similar to FIG. 1A. However, in FIG. 1B, all the responders (e.g., APs) may communicate with each other.

Referring to FIG. 1C, both the WLAN sensing initiator and the WLAN sensing responder may be the clients, and the two may communicate by connecting to the same AP.

Although FIG. 1A, FIG. 1B and FIG. 1C illustrate the case where the client acts as the initiator and the AP acts as the responder, the present disclosure is not limited thereto. For example, the AP may act as the initiator and the client may act as the responder in other examples. Furthermore, the client may also be referred to as a non-AP station (STA), or an STA for short, in various examples of the present disclosure. In addition, the number of the initiators and the number of the responders are not limited to those illustrated in FIG. 1A, FIG. 1B and FIG. 1C.

As an illustrative example, a conventional WLAN sensing measurement procedure may include: a WLAN sensing session setup phase, a WLAN sensing measurement setup phase, and a WLAN sensing measurement termination phase. In the WLAN sensing session setup phase, the initiator may initiate one or more WLAN sensing sessions. In the WLAN sensing measurement setup phase, the initiator may perform one or more WLAN sensing measurement setups. For example, for each WLAN sensing session, the initiator may establish one or more WLAN sensing measurements. The one or more established WLAN sensing measurements may be identified or distinguished by their sensing measurement setup identifiers. Each established WLAN sensing measurement may include one or more sensing measurement events, and one or more sensing measurement operations are performed in each sensing measurement event. Furthermore, an operation of reporting a sensing measurement result may be selectively performed. In the WLAN sensing measurement termination phase, the sensing measurements are stopped and the sensing sessions are terminated. In addition, the WLAN sensing measurement termination phase may also be referred to as “a WLAN sensing termination procedure”. It is to be understood that the described WLAN sensing measurement procedure is merely illustrative, and the various phases of the WLAN sensing measurement procedure may be divided differently, or some of the phases may be omitted, or some of the phases may be combined.

Furthermore, a sensing by proxy (SBP) scheme may also be adopted to efficiently utilize spectrum. An SBP procedure under the SBP scheme may be roughly divided into two phases. In the first phase, the non-AP STA may act as an SBP initiator and transmit, for example, an SBP request frame to an SBP-capable AP. The AP that receives the SBP request frame may act as an SBP responder and transmit an SBP response frame to the SBP initiator (e.g., the non-AP STA) to indicate whether to reject or accept the SBP request. The first phase may be called an SBP setup procedure. When accepting the SBP request, the AP may initiate one or more WLAN sensing measurements (e.g., the described conventional WLAN sensing measurements) with one or more non-AP STAs in the second phase. The second phase may be similar to at least a part of the phases of the described conventional WLAN sensing measurement procedure. The “one or more non-AP STAs” here may or may not include the non-AP STA that acts as the SBP initiator. In the following, for the convenience of description, the non-AP STA acting as the SBP initiator may be referred to as “an SBP initiator,” “an SBP initiator STA,” “an SBP initiator station” or “an SBP initiator station device” for short, while the non-AP STA not acting as the SBP initiator may be referred to as “a non-SBP initiator STA,” “a non-SBP initiator station” or “a non-SBP initiator station device” for short. In addition, for the convenience of description, the AP that accepts the SBP request may be referred to as “an SBP responder AP,” “an SBP responder access point” or “an SBP responder AP device” for short.

In the conventional WLAN sensing termination procedure, the sensing initiator (or the sensing responder) may initiate the termination of one or more sensing measurement setups by transmitting a sensing measurement setup termination frame (or referred to as a sensing measurement termination message frame) with a sensing measurement setup identifier of each measurement setup to be terminated to the sensing responder (or the sensing initiator). In an SBP application scenario, the SBP procedure may be terminated after the SBP responder transmits the last SBP report frame, or be terminated through transmitting an SBP terminate frame by the SBP initiator or the SBP responder. In the above description, there is a situation where the non-SBP initiator STA transmits the sensing measurement setup termination frame to the AP (which is the SBP responder), and the sensing measurement setup identifier contained in the sensing measurement setup termination frame is assigned to the STA by the SBP responder AP. Then, an SBP termination procedure may be triggered when the non-SBP initiator STA initiates the termination of the sensing measurement procedure corresponding to the sensing measurement setup identifier. Current research lacks a mechanism to avoid this situation.

In view of the above, a communication method and a communication apparatus for terminating an SBP measurement are provided according to a concept of the examples of the present disclosure.

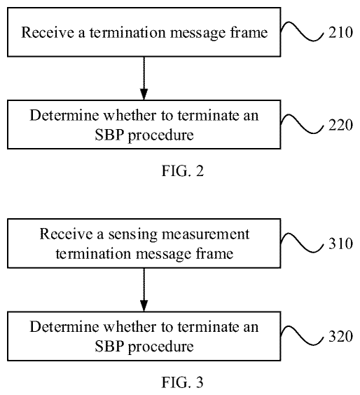

FIG. 2 is a flowchart illustrating a communication method performed by an AP according to an example. That is, the communication method illustrated in FIG. 2 may be applied to an AP device (hereinafter may be referred to as “an SBP responder AP,” or “an AP”).

Referring to FIG. 2, at step 210, the AP may receive a termination message frame from an STA; and at step 220, the AP may determine whether to terminate an SBP procedure.

In the example of FIG. 2, the STA may be an SBP initiator STA or a non-SBP initiator STA. The termination message frame may be a sensing measurement termination message frame or an SBP termination frame. In an example of the present disclosure, the AP may determine whether to terminate the SBP procedure based on the type of the STA that transmits the termination message frame. For example, when the AP receives the termination message frame transmitted from the SBP initiator STA, the AP may determine to terminate the SBP procedure. In another example of the present disclosure, the AP may determine whether to terminate the SBP procedure based on the type of the termination message frame. For example, when the termination message frame received by the AP is the SBP termination frame, the AP may determine to terminate the SBP procedure. In another example of the present disclosure, the AP may determine whether to terminate the SBP procedure based on a sensing measurement requirement of the SBP initiator STA, which is described in more detail later with reference to FIG. 5.

FIG. 3 is a flowchart illustrating a communication method performed by an AP according to an example. The communication method illustrated in FIG. 3 may be applied to an AP that acts as an SBP measurement responder.

Referring to FIG. 3, at step 310, the AP may receive a sensing measurement termination message frame transmitted from a first STA device, and at step 320, the AP may determine whether to terminate an SBP procedure. According to the example of the present disclosure, the sensing measurement termination message frame may include a sensing measurement setup identifier (MSID). The sensing measurement setup identifier may correspond to a sensing measurement procedure.

In the example of the present disclosure, the first STA device may be a non-SBP initiator STA device (a non-SBP initiator STA). That is, the communication method illustrated in FIG. 3 may be operations performed by the AP in response to the sensing measurement termination message frame from the non-SBP initiator STA.

Although not illustrated in FIG. 3, alternatively or additionally, the communication method illustrated in FIG. 3 may further include that the AP transmits an acknowledgment frame to the first STA device to indicate a termination of the sensing measurement procedure corresponding to the sensing measurement setup identifier.

When the AP receives the sensing measurement termination message frame from the non-SBP initiator STA, since the sensing measurement termination message frame transmitted by the non-SBP initiator STA may be intended to terminate the sensing measurement procedure in which the non-SBP initiator STA participates (and to which the sensing measurement setup identifier carried in the sensing measurement termination message frame corresponds), the AP is to further determine whether to terminate the SBP procedure in step 320 to avoid a false trigger on an SBP termination.

According to an example of the present disclosure, a communication method for determining the termination of the SBP procedure may be provided. The communication method includes that the AP determines whether to terminate the SBP procedure based on a sensing measurement requirement of a second STA device as an SBP initiator, and in a case of a failure to meet the sensing measurement requirement, the AP transmits an SBP termination frame to the second STA device to terminate the SBP procedure. In the example of the present disclosure, the sensing measurement requirement of the second STA device as the SBP initiator may meet a certain sensing measurement accuracy requirement. For example, the AP may obtain the sensing measurement requirement from an SBP request frame during establishing the SBP procedure. For example, alternatively or additionally, the sensing measurement requirement may include a number of STAs participating in the sensing measurement (e.g., a minimum number), a number of spatial streams, etc. The case of the failure to meet the sensing measurement requirement may refer to that the sensing measurement initiated by the AP in the SBP procedure does not meet the sensing measurement accuracy requirement of the second STA device as the SBP initiator, for example but not limited to, the number of STAs participating in the sensing measurement being less than the minimum number, or the number of spatial streams used for the sensing measurement being less than the number of spatial streams defined by the sensing measurement requirement, etc. If the required sensing measurement requirement cannot be met, it is not to continue to perform the SBP sensing measurement, and then the AP may terminate the SBP procedure by transmitting the SBP termination frame to the second STA device.

In an alternative or additional example, the SBP termination frame transmitted by the AP to the second STA device may include a first identification bit used to indicate the failure to the sensing measurement requirement. That is, the first identification bit may indicate that the reason for terminating the SBP procedure is that the sensing measurement requirement cannot be met.

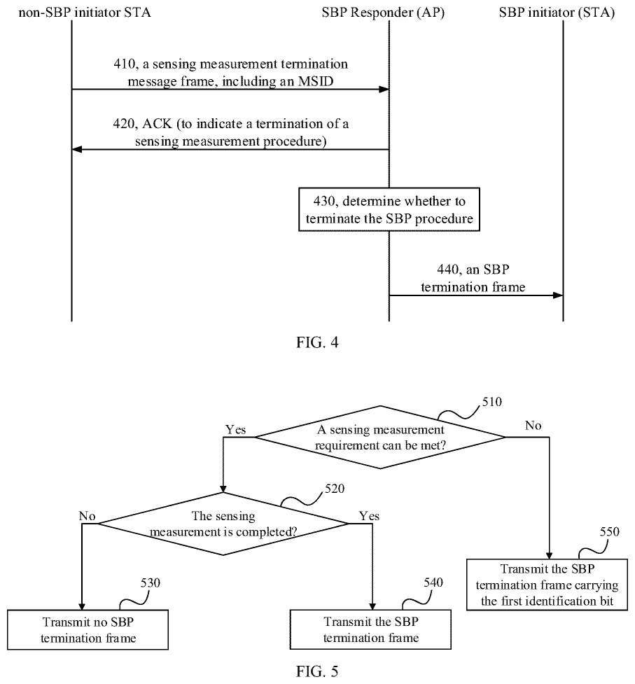

FIG. 4 is a detailed flowchart illustrating the communication method of FIG. 3 according to an example.

Referring to FIG. 4, at step 410, an SBP responder AP may receive a sensing measurement termination message frame transmitted from a non-SBP initiator STA. The sensing measurement termination message frame may include a sensing measurement setup identifier. At step 420, the SBP responder AP may transmit an acknowledgment frame (ACK) to the non-SBP initiator STA to indicate a termination of a sensing measurement procedure corresponding to the sensing measurement setup identifier. At step 430, the SBP responder AP may determine whether to terminate the SBP procedure. For example, the SBP responder AP may perform the determined operation based on a sensing measurement requirement of the SBP initiator STA. At step 440, the SBP responder AP may transmit an SBP termination frame to the SBP initiator STA when it is determined to terminate the SBP procedure.

Although FIG. 4 illustrates that step 420 and step 430 are performed sequentially, which are not limited in the present disclosure. For example, step 420 and step 430 may be performed simultaneously, or step 420 and step 430 may be performed in a reversed order.

FIG. 5 is a detailed flowchart illustrating the determination of whether to terminate an SBP procedure performed by an AP according to an example.

At step 510, the AP may determine whether a sensing measurement requirement of an SBP initiator STA (i.e., the second STA device) can be met.

If the AP determines that the required sensing measurement requirement can be met (“Yes” in step 510), step 520 is executed. If the AP determines that the required sensing measurement requirement cannot be met (“No” in step 510), step 550 is executed.

The description is made by taking an example that meeting the sensing measurement requirement of the SBP initiator STA refers to satisfying a minimum number of STAs participating in a sensing measurement.

For example, if the sensing measurement requirement of the SBP initiator STA requires at least five STAs to participate in the sensing measurement, and the AP has established the sensing measurement with five or more STAs, it may be determined that the sensing measurement requirement can be met (“Yes” in step 510), and step 520 may be executed.

At step 520, the AP may determine whether the SBP sensing measurement is completed.

For example, continuing to refer to the above example, if the sensing measurement established by the AP with five or more STAs has not been completed (“No” in step 520), at step 530, the AP may determine not to terminate the SBP procedure, that is, to transmit no SBP termination frame to the SBP initiator STA. On the contrary, if the sensing measurement established by the AP with five or more STAs are all completed (“Yes” in step 520), at step 540, the AP may determine to terminate the SBP procedure, that is, the AP may transmit the SBP termination frame to the SBP initiator STA.

For example, if the sensing measurement requirement of the SBP initiator STA requires at least five STAs to participate in the sensing measurement, and the AP has only established the sensing measurement with four or fewer STAs, the AP may determine that the required sensing measurement requirement cannot be met (“No” in step 510). Then, at step 550, the AP may determine to terminate the SBP procedure. That is, when the sensing measurement requirement cannot be met, the AP may transmit the SBP termination frame to the SBP initiator STA (e.g., the described second STA device) to terminate the SBP procedure. In other words, if the required sensing measurement requirement cannot be met, it is not to continue to perform the SBP sensing measurement, so that the SBP procedure may be terminated in advance, which can save energy, and can initiate an SBP sensing measurement that meets the sensing measurement requirement again when needed. Alternatively, or additionally, at step 550, the SBP termination frame may carry an identification bit for indicating a reason for terminating the SBP procedure. For example, the SBP termination frame may carry a first identification bit that may be set to fail to meet the sensing measurement requirement. That is, the first identification bit may indicate that the reason for terminating the SBP procedure is that the sensing measurement requirement cannot be met. As a non-limiting example, the first identification bit may be called a reason code and is carried in the SBP termination frame.

Furthermore, although not illustrated in FIG. 5, the SBP termination frame may carry the identification bit in step 540. For example, in an alternative or additional example, the identification bit carried by the SBP termination frame in step 540 may be set to indicate that the reason for terminating the SBP procedure is the completion of the SBP sensing measurement. For example, in another alternative or additional example, the identification bit carried by the SBP termination frame in step 540 may be implemented by the first identification bit, and the first identification bit may be set as a reserved bit or a value different from the value in step 550 to indicate that the reason for terminating the SBP procedure is the completion of the SBP sensing measurement.

As a non-limiting example of the present disclosure, the non-SBP initiator STA may transmit a sensing measurement termination message frame (i.e., a sensing measurement setup termination frame) to an SBP responder AP. The termination message frame may include a sensing measurement setup identifier (MSID) that may be assigned by the SBP responder AP. After receiving the termination message frame transmitted by the non-SBP initiator STA, the SBP responder AP may reply ACK to the non-SBP initiator STA to indicate the termination of the sensing measurement procedure corresponding to the MSID. In addition, the SBP responder AP may determine whether to transmit the SBP termination frame to the SBP initiator STA based on the sensing measurement requirement of the SBP initiator STA (for example, a factor such as the minimum number of STAs participating in the sensing measurement required by the SBP initiator STA during the SBP sensing measurement setup procedure). Furthermore, when the sensing measurement requirement cannot be met, the SBP termination frame transmitted by the SBP responder AP may carry the first identification bit (e.g., the reason code) to indicate that the sensing measurement requirement of the SBP initiator STA cannot be met.

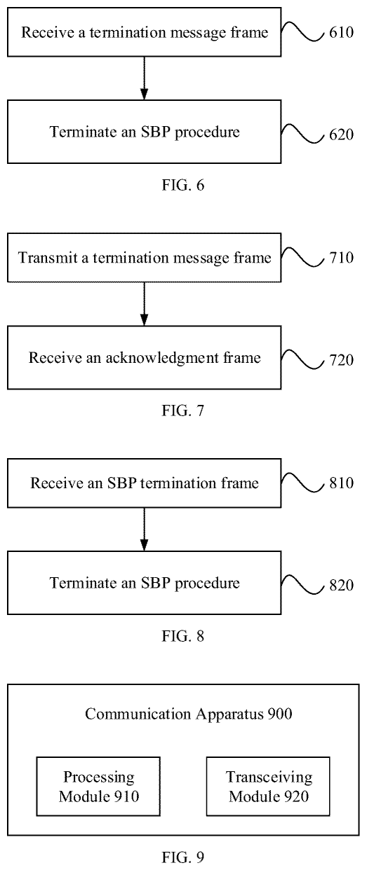

FIG. 6 is a flowchart illustrating a communication method performed by an AP according to an example. The communication method illustrated in FIG. 6 may be applied to an AP that acts as an SBP responder.

Referring to FIG. 6, at step 610, the AP may receive a termination message frame transmitted by an STA, and at step 620, the AP may terminate an SBP procedure according to the termination message frame. In the example of FIG. 6, the STA may be an SBP initiator and is capable of initiating the SBP procedure. That is, the communication method illustrated in FIG. 6 may be operations performed by the AP in response to the termination message frame from the SBP initiator STA.

According to the example of the present disclosure, the termination message frame transmitted by the STA may be an SBP termination frame or a sensing measurement termination message frame. In other words, if the SBP initiator STA participates in subsequent sensing measurement after the SBP procedure is established, it initiates not only the sensing measurement termination message frame but also the SBP termination frame to terminate the SBP procedure. In addition, in an alternative or additional example, the termination message frame (which is the sensing measurement termination message frame or the SBP termination frame) may include a sensing measurement setup identifier to indicate the termination of the SBP procedure corresponding to the sensing measurement setup identifier. The sensing measurement setup identifier may be assigned by the SBP responder AP. However, the present disclosure is not limited thereto. The sensing measurement setup identifier may be omitted from the termination frame transmitted by the SBP initiator STA.

As a non-limiting example of the present disclosure, the SBP initiator STA participates in the subsequent sensing measurement. In a case that the SBP initiator STA can initiate only a common sensing measurement procedure (e.g., a trigger-based (TB) sensing measurement and/or a non-trigger-based (Non-TB) sensing measurement), the SBP initiator STA may transmit the sensing measurement termination message frame in which the sensing measurement setup identifier assigned by the SBP responder AP cannot be included to avoid a false trigger on an SBP termination. In the example of the present disclosure, the SBP initiator STA can initiate only the common sensing measurement procedure, which may mean that the SBP initiator STA cannot initiate the SBP procedure (or an SBP sensing measurement). However, the present disclosure is not limited thereto. For example, if the SBP initiator STA can initiate only the common sensing measurement procedure, such the SBP initiator STA may be restricted to be unable to transmit the sensing measurement termination message frame, thereby avoiding the false trigger on the SBP termination.

FIG. 7 is a flowchart illustrating a communication method performed by an STA according to an example.

Referring to FIG. 7, at step 710, the STA device may transmit a termination message frame to an AP device, and at step 720, the STA device may receive an acknowledgment frame from the AP device. According to the example of the present disclosure, the AP device may be an SBP responder. The STA device may be a non-SBP initiator STA device, or may be an SBP initiator STA device, which are described in more detail in different examples below.

For example, the STA device may be the non-SBP initiator STA device, and the termination message frame in step 710 may include a sensing measurement setup identifier. In this case, after receiving the acknowledgment frame, the STA device may terminate a sensing measurement procedure corresponding to the sensing measurement setup identifier according to the acknowledgment frame. Furthermore, in this case, the termination message frame in step 710 may be a sensing measurement termination message frame. That is, in this example, the STA device may correspond to the non-SBP initiator STA in FIG. 4, and perform corresponding operations.

For example, the STA device may be the SBP initiator STA device and is able to initiate the SBP procedure. In this case, the STA device may terminate the SBP procedure according to the acknowledgment frame after receiving the acknowledgment frame. Alternatively, or additionally, the termination message frame may include the sensing measurement setup identifier to indicate the termination of the SBP procedure corresponding to the sensing measurement setup identifier. In this case, alternatively or additionally, the termination message frame in step 710 may be the SBP termination frame or the sensing measurement termination message frame.

FIG. 8 is a flowchart illustrating a communication method performed by an SBP initiator STA according to an example.

Referring to FIG. 8, at step 810, the STA device may receive an SBP termination frame transmitted from an AP device, and at step 820, the STA device may terminate an SBP procedure according to the SBP termination frame. The STA device is an SBP initiator and the AP device is an SBP responder. That is, in the example, the STA device may correspond to the SBP initiator STA in FIG. 4, and perform corresponding operations.

According to the example of the present disclosure, alternatively or additionally, the SBP termination frame in step 810 is transmitted by the AP device based on a failure to meet a sensing measurement requirement of the STA device (which is the SBP initiator STA). The required sensing measurement requirement has been described in detail in the above examples, and the repeated description is omitted here.

According to the example of the present disclosure, alternatively or additionally, the SBP termination frame in step 810 includes a first identification bit for indicating the failure to meet the sensing measurement requirement. Through the first identification bit, the SBP initiator STA may learn that the reason the SBP procedure is terminated is that the required sensing measurement requirement cannot be met.

FIG. 9 is a block diagram illustrating a communication apparatus according to an example. The communication apparatus 900 in FIG. 9 may include a processing module 910 and a transceiving module 920.

In an example of the present disclosure, the communication apparatus 900 illustrated in FIG. 9 may be applied to an AP device (which is an SBP responder AP). For example, the transceiving module 920 may be configured to receive a termination message frame, and the processing module 910 may be configured to determine whether to terminate an SBP procedure. That is, the communication apparatus 900 illustrated in FIG. 9 may perform the communication methods described with reference to FIG. 2 and FIG. 5, which are not repeated here to avoid redundancy.

In an example of the present disclosure, the communication apparatus 900 illustrated in FIG. 9 may be applied to an AP device (which is an SBP responder AP). For example, the transceiving module 920 may be configured to receive a sensing measurement termination message frame transmitted from a first STA device, where the sensing measurement termination message frame includes a sensing measurement setup identifier corresponding to a sensing measurement procedure; and the processing module 910 may be configured to determine whether to terminate an SBP procedure. That is, the communication apparatus 900 illustrated in FIG. 9 may perform the communication methods described with reference to FIG. 3 and FIG. 5 and the operations performed by the SBP responder AP in FIG. 4, which are not repeated here to avoid redundancy.

In an example of the present disclosure, the communication apparatus 900 illustrated in FIG. 9 may be applied to an AP device (which is an SBP responder AP). For example, the transceiving module 920 may be configured to receive a termination message frame transmitted from an STA device; and the processing module 910 may be configured to terminate an SBP procedure according to the termination message frame. That is, the communication apparatus 900 illustrated in FIG. 9 may perform the communication method described with reference to FIG. 6, which is not repeated here to avoid redundancy.

In an example of the present disclosure, the communication apparatus 900 illustrated in FIG. 9 may be applied to an STA device. For example, the transceiving module 920 may be configured to transmit a termination message frame to an AP device, and receive an acknowledgment frame from the AP device. The STA device may be an SBP initiator STA or a non-SBP initiator STA. That is, the communication apparatus 900 illustrated in FIG. 9 may perform the communication method described with reference to FIG. 7, which is not repeated here to avoid redundancy.

In an example of the present disclosure, the communication apparatus 900 illustrated in FIG. 9 may be applied to an STA device. For example, the transceiving module 920 may be configured to receive an SBP termination frame transmitted from an AP device, and the processing module 910 may be configured to terminate an SBP procedure according to the SBP termination frame. The STA device is an SBP initiator and the AP device is an SBP responder. That is, the communication apparatus 900 illustrated in FIG. 9 may perform the communication method described with reference to FIG. 8 and the operations performed by the SBP initiator STA in FIG. 4, which are not repeated here to avoid redundancy.

It is to be understood that the communication apparatus 900 illustrated in FIG. 9 is merely exemplary, and the examples of the present disclosure are not limited thereto. For example, the communication apparatus 900 may further include other modules such as a memory module. Furthermore, the various modules in the communication apparatus 900 may be combined into a more complex module, or may be divided into more separate modules.

The communication methods and the communication apparatuses according to the examples of the present disclosure improve the SBP termination mechanism, which can avoid the false trigger on the SBP termination and meet WLAN sensing requirements.

Based on the same principle as the methods provided by the examples of the present disclosure, an example of the present disclosure also provides an electronic device, which includes one or more processors and one or more memories. The one or more memories stores machine-readable instructions (also referred to as “a computer program”). The one or more processors are configured to execute the machine-readable instructions to implement the method described with reference to FIG. 2 to FIG. 8.

An example of the present disclosure further provides a computer-readable storage medium, with a computer program stored thereon. The computer program, when executed by one or more processors, implements the methods described with reference to FIG. 2 to FIG. 8.

In an example, the processor may be configured to implement or execute various illustrative logic blocks, modules, and circuits described in conjunction with the present disclosure, such as a central processing unit (CPU), a general-purpose processor, a digital signal processor (DSP), an application specific integrated circuit (ASIC), a field programmable gate array (FPGA), or another programmable logic component, transistor logic component, hardware component, or any combination thereof. The processor may also be a combination for implementing computing functions, such as a combination of one or more microprocessors, and a combination of a DSP and a microprocessor.

In an example, the memory may be, for example, a read only memory (ROM), a random access memory (RAM), an electrically erasable programmable read only memory (EEPROM), a compact disc read only memory (CD-ROM) or another optical disk/disc storage (including compact disc, laser disc, optical disc, digital versatile disc, Blu-ray disc, etc.), a magnetic disk storage medium or another magnetic storage device, or any other medium that may be configured to carry or store program codes in the form of instructions or data structures and is capable of being accessed by a computer, which is not limited.

Although the steps in the flowcharts of the accompanying drawings are displayed sequentially as indicated by the arrows, it is to be understood that these steps are not necessarily performed sequentially in the order indicated by the arrows. Unless otherwise specified herein, there is no strict order limitation for performing these steps and these steps may be performed in other orders. In addition, at least part of the steps in the flowcharts of the accompanying drawings may include multiple sub-steps or multiple stages. These sub-steps or stages are not necessarily performed at the same time, but may be performed at different moments. The order of these sub-steps or stages is not necessarily sequential, but may rotate or alternate with at least part of another step or sub-steps or stages of another step.

Although the present disclosure has been illustrated and described with reference to certain examples thereof, it is to be understood by those skilled in the art that various modification in form and details may be made without departing from the scope of the present disclosure. Therefore, the scope of the present disclosure should not be limited to the examples, but should be defined by the appended claims and their equivalents.

1. A communication method for terminating a sensing by proxy (SBP) measurement, performed by an access point (AP), the communication method comprising:
receiving a sensing measurement termination message frame transmitted from a first station (STA), wherein the sensing measurement termination message frame comprises a sensing measurement setup identifier corresponding to a sensing measurement procedure; and
determining whether to terminate an SBP procedure,
wherein the AP is an SBP responder.

2. The communication method according to claim 1,
wherein the first STA is a non-SBP initiator STA, and
wherein the communication method further comprises:
transmitting an acknowledgment frame to the first STA to indicate a termination of the sensing measurement procedure corresponding to the sensing measurement setup identifier.

3. The communication method according to claim 2, wherein determining whether to terminate the SBP procedure comprises:
determining whether to terminate the SBP procedure based on a sensing measurement requirement of a second STA as an SBP initiator; and
transmitting an SBP termination frame to the second STA to terminate the SBP procedure in a case of a failure to meet the sensing measurement requirement.

4. The communication method according to claim 3, wherein the SBP termination frame comprises a first identification bit for indicating the failure to meet the sensing measurement requirement.

5.-7. (canceled)

8. A communication method for terminating a sensing by proxy (SBP) measurement performed by a station (STA), the communication method comprising:
transmitting a termination message frame to an access point (AP); and
receiving an acknowledgment frame from the AP,
wherein the AP is an SBP responder.

9. The communication method according to claim 8,
wherein the STA is a non-SBP initiator STA, and the termination message frame comprises a sensing measurement setup identifier, and
wherein the communication method further comprises:
terminating a sensing measurement procedure corresponding to the sensing measurement setup identifier according to the acknowledgment frame.

10. The communication method according to claim 9, wherein the termination message frame is a sensing measurement termination message frame.

11. The communication method according to claim 8,
wherein the STA is an SBP initiator STA and is capable of initiating an SBP procedure, and
wherein the communication method further comprises:
terminating the SBP procedure according to the acknowledgment frame.

12. The communication method according to claim 11, wherein the termination message frame comprises a sensing measurement setup identifier to indicate a termination of the SBP procedure corresponding to the sensing measurement setup identifier.

13. The communication method according to claim 11,
wherein the termination message frame is an SBP termination frame or a sensing measurement termination message frame.

14.-20. (canceled)

21. An electronic device, applied to an access point (AP), comprising:
one or more memories,
one or more processors, and
a computer program stored on the one or more memories and executable on the one or more processors,
wherein the one or more processors are configured to:
receive a sensing measurement termination message frame transmitted from a first station (STA), wherein the sensing measurement termination message frame comprises a sensing measurement setup identifier corresponding to a sensing measurement procedure; and
determine whether to terminate an SBP procedure,
wherein the AP is an SBP responder.

22. A non-transitory computer-readable storage medium, wherein the computer-readable storage medium stores a computer program, and the computer program, when executed by one or more processors, implements the method according to claim 1.

23. The electronic device according to claim 21,
wherein the first STA is a non-SBP initiator STA, and
wherein the one or more processors are further configured to:
transmit an acknowledgment frame to the first STA to indicate a termination of the sensing measurement procedure corresponding to the sensing measurement setup identifier.

24. The electronic device according to claim 23, wherein the one or more processors, when configured to determine whether to terminate the SBP procedure, are configured to:
determine whether to terminate the SBP procedure based on a sensing measurement requirement of a second STA as an SBP initiator; and
transmit an SBP termination frame to the second STA to terminate the SBP procedure in a case of a failure to meet the sensing measurement requirement.

25. The electronic device according to claim 24, wherein the SBP termination frame comprises a first identification bit for indicating the failure to meet the sensing measurement requirement.

26. An electronic device, the electronic device comprising:
one or more memories,
one or more processors, and
a computer program stored on the one or more memories and executable on the one or more processors,
wherein the computer program, when collectively executed by the one or more processors, cause the electronic device to act as the STA and perform the method according to claim 8.

27. A non-transitory computer-readable storage medium, wherein the computer-readable storage medium stores a computer program, and the computer program, when executed by one or more processors of the STA, cause the STA to perform the method according to claim 8.
